(19) United States
(12) Patent Application Publication
(10) Pub. No.: US 2026/0079052 A1
(43) Pub. Date: Mar. 19, 2026

(54) HUMAN PRESENCE DETECTION SYSTEM AND HUMAN MOTION DETECTION SYSTEM

(71) Applicant: LITE-ON SINGAPORE PTE. LTD., Singapore (SG)

(72) Inventors: Saswati Dey, Singapore (SG); JUN-HUA HE, Singapore (SG); WEI JIAN JENSON NEO, Singapore (SG); George Chun-Wei Yee, Singapore (SG)

(21) Appl. No.: 19/302,063

(22) Filed: Aug. 17, 2025

(30) Foreign Application Priority Data
Sep. 13, 2024 (SG) 10202402861Y

(51) Int. Cl. G01J 5/00; G01J 5/0806; G01J 5/60

(52) U.S. Cl. CPC G01J 5/0025; G01J 5/0806; G01J 5/602; G01J 2005/604

(57) ABSTRACT

A human presence detection system and a human motion detection system. A detection apparatus that includes a thermal sensor, a lens mounted on the thermal sensor, and a controller are incorporated into the system. The lens is configured to focus thermal radiation incident from a spatial zone or the thermal radiation being radiated by an object onto the thermal sensor for sensing the thermal radiation and outputting a temperature signal. The controller incorporates filters and circuits to process the temperature signal and output digital temperature counts proportional to the thermal radiation from the spatial zone or the object. The detection apparatus can accordingly perform human presence detection or human motion detection by processing fluctuation of the digital temperature counts.

### CROSS-REFERENCE TO RELATED PATENT APPLICATION

This application claims the benefit of priority to Singapore Provisional Patent Application No. 10202402861Y, filed on Sep. 13, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an object detection technology using thermal radiation, and more particularly to systems that achieve human presence detection or human motion detection by processing fluctuation of temperature counts.

### BACKGROUND OF THE DISCLOSURE

One of the conventional technologies for achieving human presence detection or human motion detection that is currently available on the market is to incorporate a two-dimensional multi-pixel thermal sensor which is configured as a thermal imager or a sensing array with multiple thermal sensing elements. In general, the thermal imager is costly compared to a conventional one-dimensional single-pixel thermal sensor. Nevertheless, the conventional one-dimensional single-pixel thermal sensor provides poor accuracy and sharpness in human presence detection or human motion detection.

### SUMMARY OF THE DISCLOSURE

In response to the above-referenced technical inadequacies, the present disclosure provides a technical solution for achieving instant and accurate human presence detection or human motion detection, and can be applied to applications in areas of security and surveillance, healthcare, smart homes, retail, customer analytics, search and rescue operations.

In one of the embodiments of the human presence detection system, the human presence detection system includes a thermal sensor, a lens mounted on the thermal sensor, and a controller. The lens is configured to focus thermal radiation incident from a spatial zone onto the thermal sensor, wherein the thermal sensor is configured to sense the thermal radiation from the spatial zone and output a temperature signal. The controller is coupled to the thermal sensor. The controller is configured to set a first threshold and a second threshold, wherein the first threshold is greater than the second threshold, and to detect human presence according to the temperature signal, the first threshold and the second threshold. The controller includes a low-pass filter and a Kalman filter. The controller is further configured to input the temperature signal into the low-pass filter, and the low-pass filter is configured to output a filtered temperature signal. The controller is further configured to obtain a first difference signal by computing a difference between the temperature signal and the filtered temperature signal. The controller is further configured to input the first difference signal into the Kalman filter, and the Kalman filter is configured to output a second difference signal.

Further, in one aspect, in response to the second difference signal being less than the first threshold and greater than the second threshold, the controller determines that there is no human presence; in response to the second difference signal being greater than both the first threshold and the second threshold, the controller determines that there is human presence; and, in response to the second difference signal being less than both the first threshold and the second threshold, the controller determines that there is human presence.

In one embodiment of the human motion detection system, the human motion detection system includes a thermal sensor, a lens mounted on the thermal sensor, and a controller. The lens is configured to focus thermal radiation incident from a spatial zone onto the thermal sensor, wherein the thermal sensor is configured to sense the thermal radiation from the spatial zone and output a temperature signal. The controller is coupled to the thermal sensor. The controller is configured to set a first threshold and a second threshold, wherein the first threshold is greater than the second threshold, and to detect human motion according to the temperature signal, the first threshold and the second threshold. The controller includes a differentiator and a median filter. The controller is configured to input the temperature signal into the differentiator, and the differentiator is configured to output a rate of change of the temperature signal. The controller is further configured to input the rate of change of the temperature signal into the median filter, and the median filter is configured to output a filtered rate of change of the temperature signal.

In one aspect, in response to the filtered rate of change of the temperature signal being less than the first threshold and the filtered rate of change of the temperature signal being greater than the second threshold, the controller determines that there is no human motion; in response to the filtered rate of change of the temperature signal being greater than both the first threshold and the second threshold, the controller determines that there is human motion; and, in response to the filtered rate of change of the temperature signal being less than both the first threshold and the second threshold, the controller determines that there is human motion.

In one embodiment of the human motion detection system, the human motion detection system includes a thermal sensor, a lens mounted on the thermal sensor and a controller. The lens is configured to focus thermal radiation incident from a spatial zone onto the thermal sensor, wherein the thermal sensor is configured to sense the thermal radiation from the spatial zone and output a temperature signal. The controller is coupled to the thermal sensor. The controller is configured to set a first threshold and a second threshold, wherein the first threshold is greater than the second threshold, and to detect human motion according to the temperature signal, the first threshold and the second threshold. The controller is further configured to perform a convolution process on the temperature signal to obtain a convolution signal.

In one aspect, in response to the convolution signal being less than the first threshold and greater than the second threshold, the controller determines that there is no human motion; in response to the convolution signal being greater than both the first threshold and the second threshold, the controller determines that there is human motion; and, in response to the convolution signal being less than both the first threshold and the second threshold, the controller determines that there is human motion.

Further, in the convolution process, the controller obtains a quantity of samples to be convoluted, and performs the following processes for each of the samples to be convoluted, in which the controller obtains values of a current state and a previous state of the temperature signal, computes a time difference between the current state and the previous state, obtaining a plurality of convolution values by multiplying the value of the current state, the value of the previous state and the time difference, and obtains a sum of the plurality of convolution values to obtain the convolution signal.

Still further, the controller includes a low-pass filter, and the controller inputs the convolution signal into the low-pass filter, and the low-pass filter outputs a filtered convolution signal. In one further aspect, in response to the filtered convolution signal being less than the first threshold and greater than the second threshold, the controller determines that there is no human motion; in response to the filtered convolution signal being greater than both the first threshold and the second threshold, the controller determines that there is human motion; and, in response to the filtered convolution signal being less than both the first threshold and the second threshold, the controller determines that there is human motion.

Accordingly, in the human presence detection system or in the human motion detection system provided by the disclosure, the algorithm performed by the controller achieves great improvements to accuracy and speed of human presence detection or human motion detection while minimizing cost of hardware since the detection system includes a thermal sensor only, such as a single pixel thermal sensor, instead of multiple thermal sensors.

These and other aspects of the disclosure will become apparent from the following description of the embodiments taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1A is a block diagram illustrating a human presence detection system according to certain embodiments of the disclosure;

FIG. 1B is a schematic diagram depicting a thermal detection apparatus in a three-dimensional form according to certain embodiments of the disclosure;

FIG. 1C is a schematic diagram illustrating an aspect of focusing thermal radiation incident from a spatial zone onto a thermal sensor according to certain embodiments of the disclosure;

FIG. 2 is a schematic diagram depicting an exemplary scenario of performing human presence detection in one embodiment of the disclosure;

FIG. 3 is a flow diagram illustrating an exemplary operating process of the human presence detection system according to one embodiment of the disclosure;

FIG. 4 is a schematic diagram illustrating a process of human presence detection according to one embodiment of the disclosure;

FIG. 5 is a flow diagram illustrating the process of human presence detection in several scenarios according to one embodiment of the disclosure;

FIG. 6 is another flow diagram illustrating a process of human presence detection according to another embodiment of the disclosure;

FIG. 7 is one further flow diagram illustrating a process of human presence detection according to one further embodiment of the disclosure;

FIG. 8 is a block diagram illustrating a human motion detection system according to certain embodiments of the disclosure;

FIG. 9 is a flow diagram illustrating an exemplary operating process of the human motion detection system according to one embodiment of the disclosure;

FIG. 10 is a schematic diagram illustrating a process of human motion detection according to one embodiment of the disclosure;

FIG. 11 is a flow diagram illustrating the process of human motion detection in several scenarios according to one embodiment of the disclosure;

FIG. 12 is another flow diagram illustrating an exemplary operating process of the human motion detection system according to another embodiment of the disclosure;

FIG. 13 is another schematic diagram illustrating a process of human motion detection according to another embodiment of the disclosure;

FIG. 14 is a flow diagram illustrating a convolution process according to one embodiment of the disclosure;

FIG. 15 is another flow diagram illustrating the process of human motion detection in several scenarios according to another embodiment of the disclosure; and

FIG. 16 is one further flow diagram illustrating the process of human motion detection in several scenarios according to one further embodiment of the disclosure.

### DETAILED DESCRIPTION OF THE EXEMPLARY EMBODIMENTS

The disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a human presence detection system and a human motion detection system that are implemented by a thermal detection apparatus and a controller that performs algorithms for detecting human presence or human motion through collaboration of hardware and software. One of the objectives of the systems is to improve accuracy of human presence detection and human motion detection with a low-cost and efficient solution. Further, the technical solution for achieving instant and accurate human presence detection or human motion detection can be applied to applications in areas of security and surveillance, healthcare, smart homes, retail, customer analytics, search and rescue operations.

In one aspect of the human presence detection system or the human motion detection system, the thermal detection apparatus incorporates a thermal sensor that is configured to sense thermal radiation from the surrounding environment, and the algorithm performed by the controller is to process changes of digital temperature counts while converting the sensed thermal radiation into digital signals for determining whether any person is present or moving in front of the thermal detection apparatus. Therefore, human presence or human motion can be detected once the digital temperature counts are determined to reach a detection threshold. Specifically, the thermal sensor of the thermal detection apparatus can be an infrared (IR) sensor that is configured to sense infrared radiation that is radiated by an object (e.g., a human body).

### Embodiment 1: Human Presence Detection System

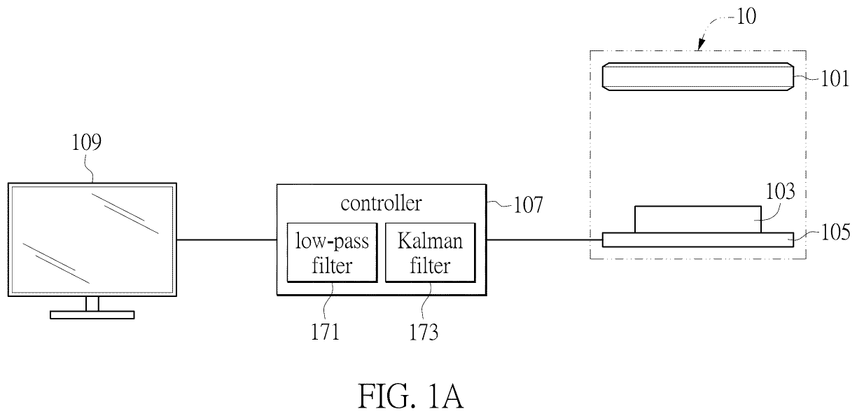

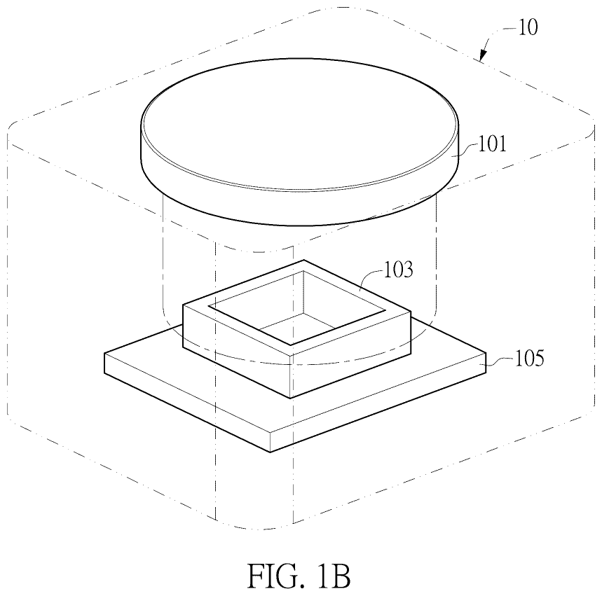

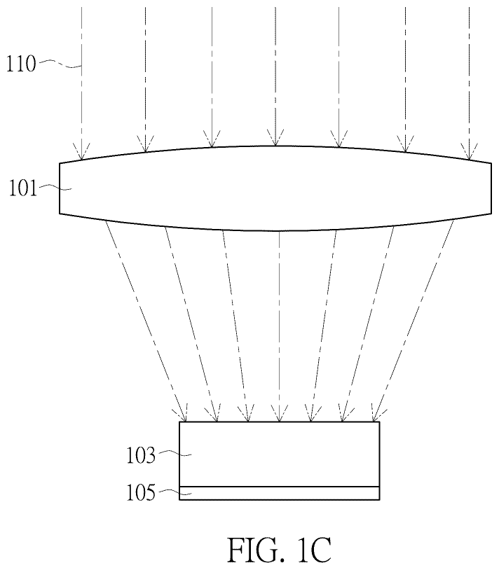

Reference is made to FIG. 1A, which is a block diagram illustrating a human presence detection system, in view of FIG. 1B, which schematically illustrates a thermal detection apparatus 10 in a three-dimensional form, and further in view of FIG. 1C schematically illustrating an aspect of focusing thermal radiation incident from a spatial zone onto a thermal sensor according to certain embodiments of the present disclosure.

A thermal detection apparatus 10 is provided in the human presence detection system of the present embodiment. The thermal detection apparatus 10 includes a lens 101, a thermal sensor 103, and a circuit board 105. A controller 107 that is electrically connected with the circuit board 105 of the thermal detection apparatus 10 can be an external component in this solution or can also be a component installed inside the thermal detection apparatus 10.

The circuit board 105 implements a control circuit for controlling operations of the thermal sensor 103. The circuit board 105 is electrically connected with controller 107 of the human presence detection system, and is configured to drive the thermal sensor 103 to operate according to a control signal generated by the controller 107, for example, to sense the thermal radiation 110 that is radiated from an object and convert the thermal radiation 110 into a temperature signal. The lens 101 is mounted on the thermal sensor 103. The lens acts as a radiation focusing device that is configured to focus the thermal radiation 110 incident from a spatial zone onto the thermal sensor 103. Therefore, the thermal sensor 103 is able to sense the focused thermal radiation 110 from the spatial zone and output the temperature signal.

The controller 107 is used to operate functionality of the thermal detection apparatus 10 such as activating the thermal sensor 103 to be driven for sensing the thermal radiation 110 and generating the temperature signal. The controller 107 is configured to perform the algorithm to achieve human presence detection. In certain embodiments of the present disclosure, the controller 107 sets a first threshold and a second threshold, and the first threshold is specified to be greater than the second threshold. After receiving the temperature signal from the thermal detection apparatus 10 via a connection (e.g., a signaling line or a flexible circuit board) with the circuit board 105, the controller 107 performs human presence detection according to the temperature signal, the first threshold and the second threshold.

A host 109 is introduced in the human presence detection system. The host 109 can be used to monitor the progress when the controller 107 performs the algorithm for human presence detection, and a result of human presence detection can be provided for the host 109, for example, using a display to visualize the progress and the result of human presence.

Further, according to the embodiment as shown in the diagram of FIG. 1A, the controller 107 includes a low-pass filter 171 and a Kalman filter 173. The controller 107 is configured to input the temperature signal into the low-pass filter 171, which, for example, is configured to introduce a phase delay in the temperature signal based on a processing time of the low-pass filter 171, and then output a filtered temperature signal. After that, the controller 171 obtains a first difference signal by computing a difference between the temperature signal and the filtered temperature signal, and inputs the first difference signal into the Kalman filter 173, and the Kalman filter 173 is configured to output a second difference signal.

In one of the embodiments of the disclosure, while receiving the first difference signal, the Kalman filter 173 performs smoothening on the first difference signal and outputs a smoothed version of the first difference signal, i.e., the second difference signal. It should be noted that the first difference signal and the second difference signal have a mean value of zero, and therefore it is not necessary to acquire an ambient temperature and to compute the mean value. Further, the first difference signal and the second difference signal are centered around zero. The first threshold is an upper threshold and may be a number greater than zero. The second threshold is a lower threshold and may be another number less than zero.

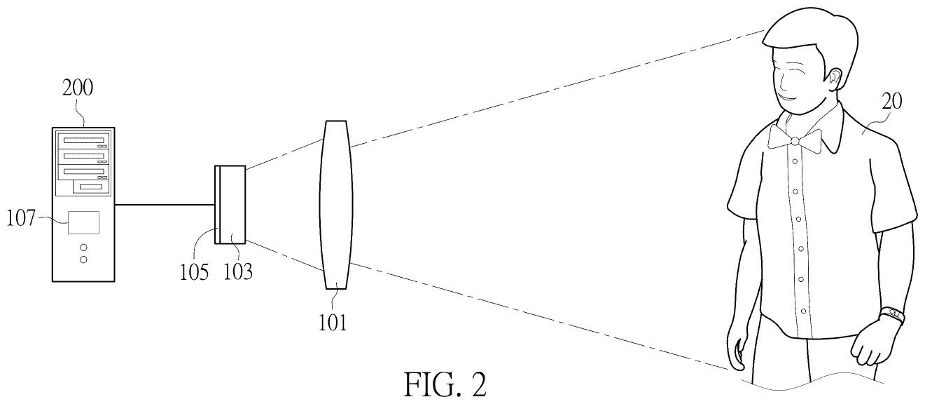

Based on the above-described setup of the human presence detection system, FIG. 2 then shows a schematic diagram depicting an exemplary scenario of performing human presence detection in one embodiment of the disclosure.

As shown in the diagram, an assembly of the thermal detection apparatus (10, FIG. 1A and FIG. 1B) according to the above embodiments includes the lens 101, the thermal sensor 103 and the circuit board 105. In the present embodiment, the controller 107 can be implemented by a microcontroller (MCU) installed inside a host 200.

According to the embodiments of the disclosure, the thermal sensor 103 can be an infrared sensor that can be used to sense the thermal radiation from a person 20 in front of the thermal detection apparatus onto a sensing window of the thermal sensor 103, the thermal radiation passes through the lens 101 being mounted on the thermal sensor 103. The lens 101 is configured to focus the thermal radiation to be radiated onto the thermal sensor 103, and the thermal sensor 103 senses the thermal radiation.

After the circuit board 105 that performs analog-to-digital conversion converts the analog signals sensed by the thermal sensor 103 into the digital temperature signal, the controller 107 receives the temperature signal. Further, the controller 107 performs human presence detection through collaboration of the setup of hardware and the algorithm that is performed according to the temperature signal, the first threshold and the second threshold.

It should be noted that, rather than the conventional two-dimensional multi-pixel thermal sensor, the thermal sensor 103 can be a one-dimensional single pixel thermal sensor (e.g., the infrared sensor) that provides a low-cost solution but still with high accuracy based on the several embodiments of the disclosure.

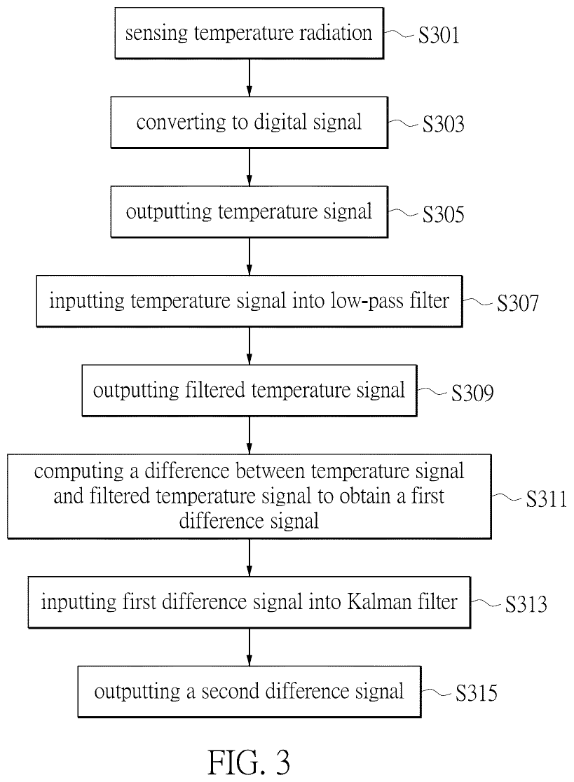

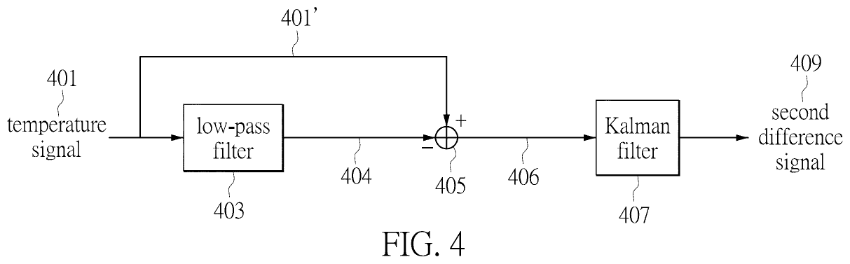

FIG. 3 is a flow diagram illustrating an exemplary operating process of the human presence detection system. FIG. 4 is a schematic diagram illustrating a process of human presence detection according to another embodiment of the disclosure.

After the thermal detection apparatus is initialized, the thermal sensor of the thermal detection apparatus is driven to sense thermal radiation radiated from an object (step S301). For example, after the thermal sensor senses thermal radiation, the circuit board of the thermal sensor receives analog electrical signals and then performs analog-to-digital conversion in order to convert the analog electrical signals into digital signals, i.e., the temperature signal 401 (step S303). After that, the circuit board of the thermal sensor outputs the temperature signal 401 to the controller (step S305).

As shown in FIG. 4, the controller includes the low-pass filter 403 and Kalman filter 407. The controller inputs the temperature signal 401 into the low-pass filter 403 (step S307) and outputs a filtered temperature signal 404 (step S309). After that, the controller uses an operator (e.g., a subtractor 405) to compute a difference between the temperature signal 401′ (the same as the inputted temperature signal 401) and filtered temperature signal 404 so as to obtain a first difference signal 406 (step S311). The subtractor 405 subtracts the value of the filtered temperature signal 404 from the temperature signal 401′.

The first difference signal 406 is then inputted into the Kalman filter 407 (step S313). For example, the Kalman filter 407 is configured to perform a smoothening process on the first difference signal 406 and then outputs a second difference signal 409, i.e., a smoothened version of the first difference signal 406 (step S315).

In certain embodiments of the disclosure, the low-pass filter 403 may be a weighted low-pass filter. The low-pass filter 403 may introduce a phase delay in the temperature signal 401. The low-pass filter 403 may perform weighted moving average (WMA) filtering that computes an arithmetic mean of the temperature signal 401 when no human presence is detected, and this mean of the temperature signal 401 acts as a baseline signal. Accordingly, variable detection thresholds are computed from the baseline of the temperature signal 401 so as to make the human presence detection more robust by reducing the fluctuations (e.g., filtering out system noises) of the input signals, i.e., the above-mentioned temperature signal 401.

In an exemplary embodiment, the thermal sensor defines a field of view (FOV). When no human is present within the FOV of the thermal sensor, the first threshold (e.g., an upper threshold) and the second threshold (e.g., the lower threshold) are parallel and a delta offset from the mean of the temperature signal 401 is defined. While the system is in operation or no human presence is detected and a DC level of the temperature signal 401 changes due to system imperfections, the variable detection thresholds also change proportionately. Thus, the mechanism of variable detection thresholds can effectively prevent false human presence detection and allow users to set up thresholds correctly, so that a human presence detection range of the system can be improved.

For example, once human presence is detected within the FOV of the thermal sensor, the temperature signal 401 changes with respect to the detection thresholds that are configured to be fixed. Otherwise, once no human presence is detected, e.g., a human body moves away from the FOV of the thermal sensor, the temperature signal 401 reaches a steady state, and the detection thresholds are again computed and updated for facilitating the following human presence detection.

According to another embodiment of the disclosure, the thermal sensor is implemented by an infrared sensor. The infrared sensor senses the infrared radiation and then outputs digital temperature counts after performing analog-to-digital conversion, thus obtaining the temperature signal 401. The digital temperature counts are proportional to the infrared radiation.

In another embodiment of the disclosure, since the digital temperature counts may fluctuate due to poor sensor accuracy and changes of the temperature of the surrounding environment, the human presence detection system uses the Kalman filter 407 to perform the smoothening process on the first difference signal 406 (i.e., the smoothened version of the first difference signal 406).

As described above, the low-pass filter 403 introduces a phase delay in the temperature signal 401 and outputs the filtered temperature signal 404. When the first difference signal 406 is computed, the Kalman filter 407 reduces high frequency fluctuations caused by system imperfections and system noises.

Thus, when human presence is detected within the FOV of the thermal sensor, a sharp change in the second difference signal 409 without fluctuations appears in the baseline that results in a stable human presence detection. The second difference signal 409 increases sharply if the object temperature is higher than the ambient temperature under an indoor condition. On the contrary, if the object temperature is lower than the ambient temperature in an outdoor condition, the second difference signal 409 decreases sharply and human presence is detected.

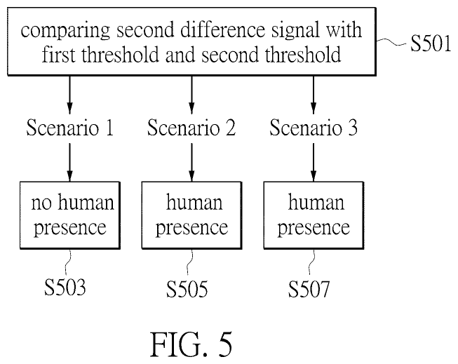

FIG. 5 is a flow diagram illustrating the process of human presence detection in several scenarios according to one embodiment of the disclosure.

As described above, the controller of the human presence detection system is configured to set the first threshold and the second threshold that is smaller than the first threshold. When the second difference signal 409 is obtained, the second difference signal 409 is compared with the first threshold and the second threshold in order to detect human presence (step S501).

In response to the second difference signal being less than the first threshold and greater than the second threshold, scenario 1 is met, and the controller is configured to determine that there is no human presence (step S503). In response to the second difference signal being greater than both the first threshold and the second threshold, scenario 2 is met, and the controller is configured to determine that there is human presence (step S505). In response to the second difference signal being less than both the first threshold and the second threshold, scenario 3 is met, and the controller is configured to determine that there is human presence (step S507).

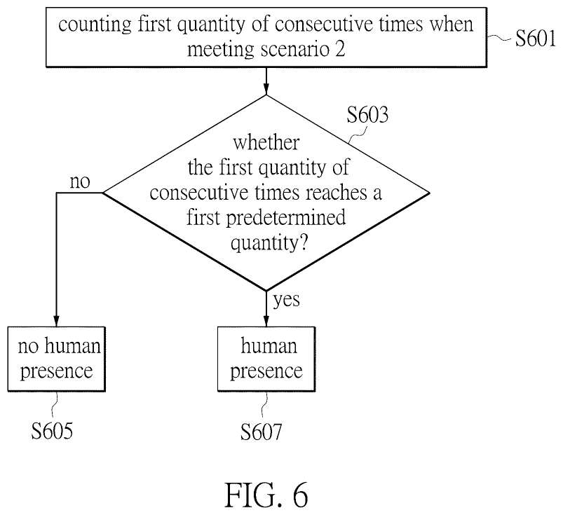

FIG. 6 is another flow diagram illustrating a process of human presence detection that further considers consecutive times when scenario 2 is met according to another embodiment of the disclosure.

The human presence detection system sets a first predetermined quantity for confirming human presence under scenario 2, which means that the above-described second difference signal is greater than both the first threshold and the second threshold.

In the exemplary process, the controller of the human presence detection system is configured to count a first quantity of consecutive times that scenario 2 is met (step S601), and it is determined whether the first quantity reaches the first predetermined quantity (step S603).

In response to the first quantity of consecutive times that scenario 2 is met not reaching the first predetermined quantity (represented as “No”), the controller is configured to confirm that there is no human presence (step S605); otherwise, in response to the first quantity reaching the first predetermined quantity (represented as “Yes”), human presence is confirmed (step S607).

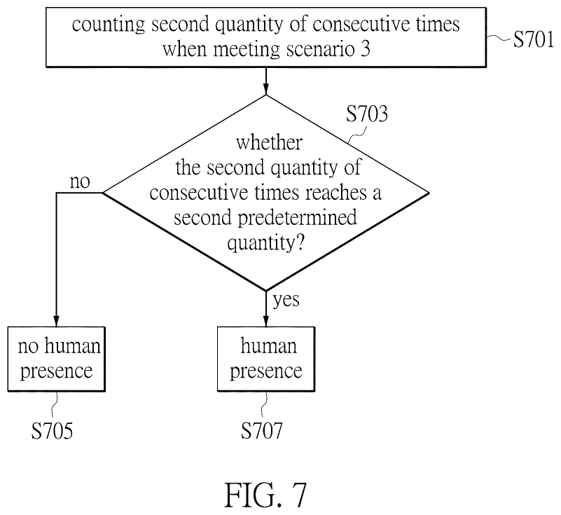

FIG. 7 is another flow diagram illustrating one further process of human presence detection that further considers consecutive times when scenario 3 is met according to another embodiment of the disclosure.

The human presence detection system sets a second predetermined quantity for confirming human presence under scenario 3, which means that the second difference signal is less than both the first threshold and the second threshold. In the process of human presence detection, the controller is configured to count a second quantity of consecutive times that scenario 3 is met (step S701), and it is also determined whether the second quantity reaches the second predetermined quantity (step S703).

In response to the second quantity of consecutive times not reaching the second predetermined quantity (represented as “No”), no human presence is determined (step S705). On the contrary, if the second quantity reaches the second predetermined quantity (represented as “Yes”), human presence is confirmed (step S707).

### Embodiment 2: Human Motion Detection System

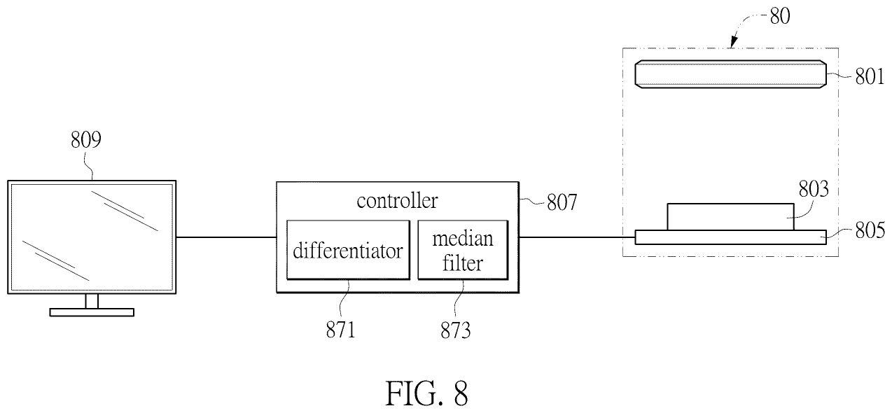

FIG. 8 is a block diagram illustrating a human motion detection system according to another embodiment of the disclosure.

The human motion detection system includes a thermal detection apparatus 80 and a controller 807. The thermal detection apparatus 80 includes a lens 801, a thermal sensor 803 and a circuit board 805. The lens 801 is mounted on the thermal sensor 803. The controller 807 is electrically connected with the circuit board 805 of the thermal detection apparatus 80 and on the other side connected with a host 809. The host 809 can be used to monitor the progress when the controller 107 performs the algorithm for human motion detection and displays a result of human motion detection, for example, using a display to visualize the progress and the result of human motion.

The controller 807 includes a differentiator 871 and a median filter 873. In an embodiment of the disclosure, the differentiator 871 generates an output signal proportional to a rate of change of the temperature signal received from the thermal detection apparatus 80. Specifically, the differentiator 871 is configured to perform a mathematical differentiation in order to output a signal that reflects the rate of change of the temperature signal.

The median filter 873 smoothens the rate of change of the temperature signal. A median filter replaces the entries of the input with the median of the entry and its neighboring entries. For example, consider the sequence {0, 1, −1, 5, 2, 1} as the values of the rate of change of the temperature signal. For this example, the median filter 873 outputs the sequence {0, 0, 1, 2, 2, 1}. The entries of the output sequence have more similar values than the entries of the input sequence, and the entry value 5 has been filtered out since it is high compared to neighboring entry values −1 and 2, wherein the median filter 873 selects value 2 since it is the median of −1, 5 and 2. Accordingly, the controller 807 uses an output of the median filter to detect human motion according to the temperature signal and some predetermined thresholds.

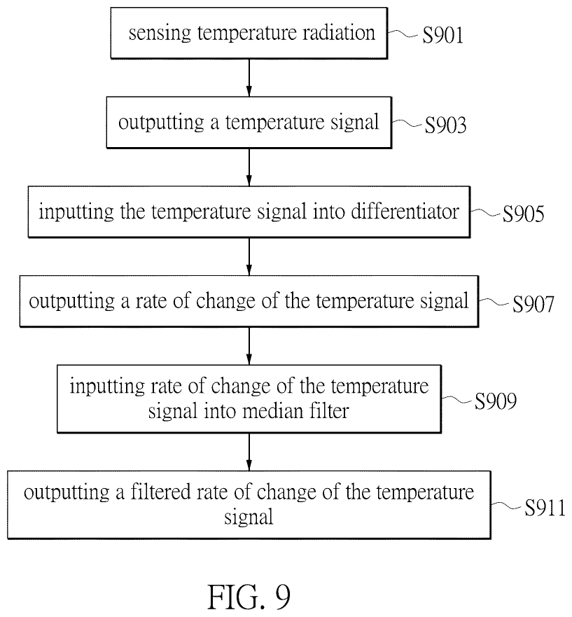

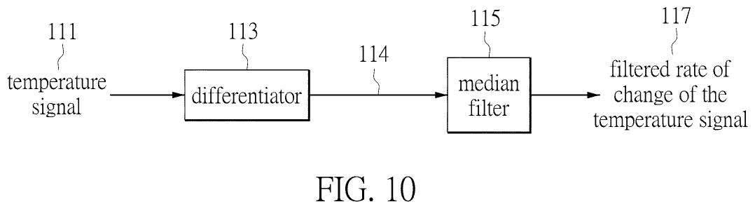

FIG. 9 is a flow diagram illustrating an exemplary operating process of the human motion detection system and in view of the schematic diagram shown in FIG. 10 according to one embodiment of the disclosure.

In the beginning of the flowchart illustrated in FIG. 9, the thermal sensor 803 senses thermal radiation incident from a spatial zone. The lens 801 is configured to focus the thermal radiation onto the thermal sensor 803 (step S901). The thermal detection apparatus 80 then outputs a temperature signal (step S903).

Next, referring to FIG. 10, the controller 807 inputs the temperature signal 111 into the differentiator 113 (step S905) and the differentiator 111 is configured to output the rate of change of the temperature signal 114 (step S907). After that, the controller 807 inputs the rate of change of the temperature signal 114 into the median filter 115 (step S909). One of the objectives of the median filter 115 is to remove high frequency noise and rapid fluctuations of the signals. Through the operations made by the median filter 115, the controller 807 outputs a filtered rate of change of the temperature signal 117 (step S911).

The rate of change of the temperature signal 114 and the filtered range of change of the temperature signal 117 have a mean value of zero. Thus, it is not necessary to acquire an ambient temperature and compute the mean value. Specifically, these rate-of-change signals are centered around zero.

For the purpose of human motion detection, according to certain embodiments of the disclosure, the controller is configured to set a first threshold (e.g., an upper threshold) and a second threshold (e.g., a lower threshold), i.e., the first threshold is greater than the second threshold. Moreover, the first threshold may be a value greater than zero and the second threshold may be another value less than zero. Accordingly, the controller performs human motion detection according to the temperature signal, the first threshold and the second threshold.

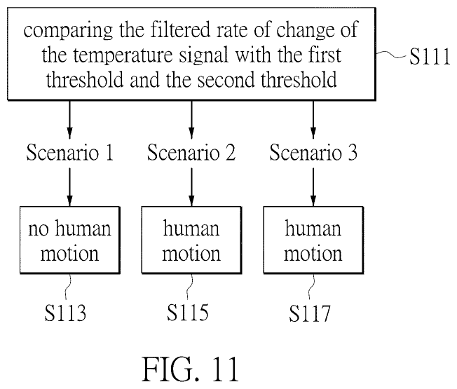

FIG. 11 is a flow diagram illustrating the process of human motion detection in several scenarios according to another embodiment of the disclosure.

The controller is configured to compare the filtered rate of change of the temperature signal with the first threshold and the second threshold for detecting human motion (step S111).

In response to the filtered rate of change of the temperature signal being less than the first threshold and greater than the second threshold, scenario 1 is met, and the controller is configured to determine that there is no human motion (step S113). In response to the filtered rate of change of the temperature signal being greater than both the first threshold and the second threshold, scenario 2 is met, and the controller is configured to determine that there is human motion (step S115). In response to the filtered rate of change of the temperature signal being less than both the first threshold and the second threshold, scenario 3 is met, and the controller is configured to determine that there is human motion (step S117).

Changes of the temperature signal between a current state and a previous state are computed in real time. The time changes are also computed in real time. Derivative of the temperature signal is computed to measure a rate of change of the temperature signal by using Equation 1. “Obj Derivative” is the rate of change of the temperature signal. “ΔObj ADC” is the change in the temperature signal between a current state and a previous state. “Δtimestamp” is the change in time.

$$Obj Derivative = \frac{Δ Obj ADC}{Δtimestamp} . \qquad Equation 1$$

The rate of change of the temperature signal is further processed through the median filter (median filter 115 of FIG. 10) to remove high frequency noise and rapid fluctuations of the signals. When no human presence is detected within the FOV of thermal sensor, the filtered “Obj Derivative” count signal amplitude is near zero. User defined thresholds are also provided to achieve more accurate human motion detection at a long range.

When a person passes through the FOV of thermal sensor, the rate of change of the temperature signal “Obj Derivative” increases and crosses an upper threshold if the person approaches towards the FOV of the thermal sensor, and accordingly human motion is detected. On the contrary, the rate of change of the temperature signal “Obj Derivative” decreases and crosses a lower threshold if a person recedes from the FOV of the thermal sensor, and the human motion is also detected.

### Embodiment 3: Human Motion Detection System

As described above, the human motion detection system performs human motion detection by processing a rate of change of the temperature signal 114. The controller 807 may compute convolution, derivative and filtering on the temperature signal for generating a filtered convoluted object temperature signal as well as filtered derivative of temperature signal that are compared against adjustable detection thresholds to trigger human motion detection and display the result.

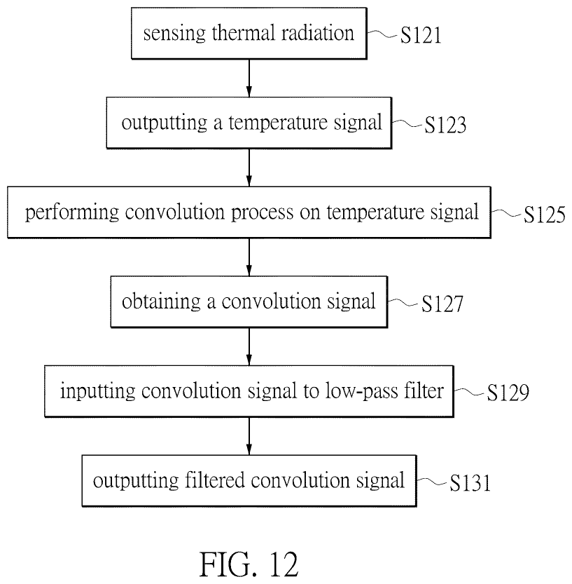

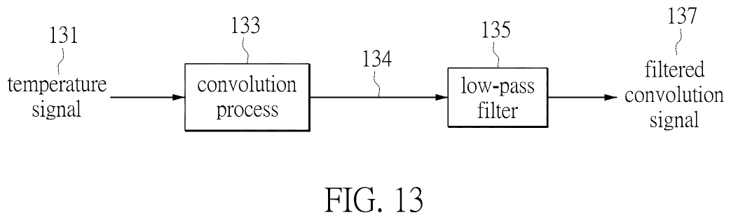

FIG. 12 is one further flow diagram illustrating an exemplary operating process with a convolution process of the human motion detection system in view of FIG. 13. FIG. 13 is another schematic diagram illustrating a process of human motion detection according to another embodiment of the disclosure.

The above-described thermal detection apparatus of the human motion detection system is configured to sense thermal radiation (step S121) and output a temperature signal 131 (step S123). The temperature signal 131 may be a digital signal being converted from the thermal radiation sensed by the thermal sensor.

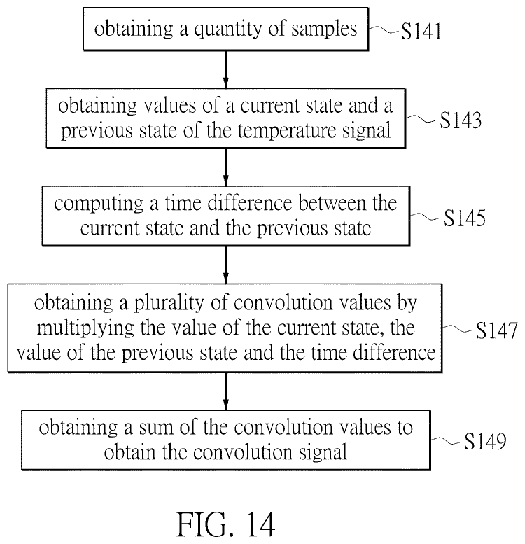

In order to make the human motion detection scheme more robust, the controller coupled to the thermal sensor is configured to perform the convolution process 133 on the temperature signal 131 (step S125) and then obtain a convolution signal 134 (step S127). Reference is also made to FIG. 14. FIG. 14 is an exemplary flowchart illustrating the convolution process 133.

Next, the controller inputs the convolution signal 134 to a low-pass filter 135 (step S129). In another embodiment of the disclosure, the low-pass filter 135 may be a weighted moving average filter (WMA) that allows the recent signals to be assigned with higher weights for reducing the fluctuations of the input signals, i.e., the convolution signal(s). After that, the controller outputs a filtered convolution signal 137 (step S131).

It should be noted that the convolution signal 134 and the filtered convolution signal 137 have a mean value of zero, and therefore it is not necessary for the human motion detection system to acquire an ambient temperature and compute the mean value.

Further, for performing human motion detection, the controller coupled to the thermal sensor is configured to set a first threshold and a second threshold, in which the first threshold can be an upper threshold that is greater than zero, and the second threshold can be a lower threshold that is less than zero. Therefore, the first threshold is greater than the second threshold. The controller then performs human motion detection according to the temperature signal 131, the first threshold and the second threshold.

The temperature signal is convoluted with its previous state to generate a convolution signal. The convolution signal is further processed through weighted moving average to reduce signal fluctuations. When no human presence is detected, the convolution signal is a near-zero amplitude signal that acts as a baseline. The convolution signal may be computed with Equation 2.

$$Convolution ( t ) = {\sum }_{i = 0}^{N - 1} Obj ADC ( t - i ) \cdot Previous Obj ADC ( i ) \cdot Δ t . \qquad Equation 2$$

In Equation 2, “Obj ADC(t)” is the current state of the temperature signal at time “t”; “previous Obj ADC (i)” is the previous state of the temperature signal at time “i”; “Δt” is a delta timestamp; and “N” is the number of convoluted samples.

The convolution signal is the sum of the product of the current state and previous state of the temperature signal that is weighted by the delta timestamp over a range of samples. The convolution process shows high changes in the convolution signal when human motion is detected within a field of view (FOV) of the thermal sensor.

FIG. 14 shows a flow diagram illustrating the above-described convolution process 133 according to an embodiment of the disclosure.

In the convolution process 133 applied to the human motion detection system, a quantity of samples is obtained (step S141) and the controller of the human motion detection system performs the following steps of the convolution process. Values of a current state and a previous state of the temperature signal that is received from the thermal detection apparatus are firstly obtained (step S143). The controller then computes a time difference between the current state and the previous state (step S145), so as to obtain a convolution value by multiplying the value of the current state, the value of the previous state, and the time difference (step S147). After repeating the above steps, a sum of a plurality of convolution values can be obtained so as to obtain a convoluted object signal (step S149).

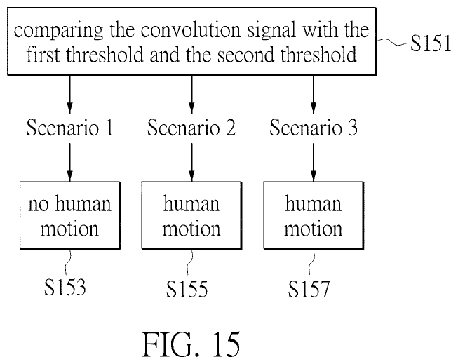

FIG. 15 is another flow diagram illustrating the process of human motion detection in several scenarios being determined based on the convolution signal, the first threshold and the second threshold predetermined by the controller according to another embodiment of the disclosure.

In the human motion detection system, the controller compares the convolution signal with the first threshold and the second threshold (step S151).

In response to the convolution signal being less than the first threshold and greater than the second threshold, scenario 1 is met, and the controller is configured to determine that there is no human motion. (step S153). In response to the convolution signal being greater than both the first threshold and the second threshold, scenario 2 is met, and the controller is configured to determine that there is human motion (step S155). In response to the convolution signal being less than both the first threshold and the second threshold, scenario 3 is met, and the controller is configured to determine that there is human motion (step S157).

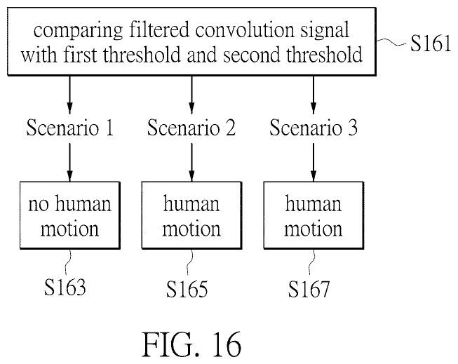

In one further aspect of the disclosure, the controller is configured to input the convolution signal into the low-pass filter so as to output a filtered convolution signal. The related flowchart is shown in FIG. 16, which is a flowchart illustrating the process of human motion detection in several scenarios being determined based on the filtered convolution signal, the first threshold and the second threshold predetermined by the controller according to another embodiment of the disclosure.

The controller compares the filtered convolution signal with the first threshold and the second threshold (step S161).

In response to the filtered convolution signal being less than the first threshold and greater than the second threshold, scenario 1 is met, and the controller is configured to determine that there is no human motion. In response to the filtered convolution signal being greater than both the first threshold and the second threshold, scenario 2 is met, and the controller is configured to determine that there is human motion. In response to the filtered convolution signal being less than both the first threshold and the second threshold, scenario 3 is met, and the controller is configured to determine that there is human motion.

Furthermore, according to one of the embodiments of the disclosure, the controller is further configured to count a third quantity of consecutive times that the convolution signal is greater than both the first threshold and the second threshold, in which, in response to the third quantity of consecutive times reaching a third predetermined quantity, the controller is configured to determine that there is human motion.

Still further, the controller is further configured to count a fourth quantity of consecutive times that the convolution signal is less than both the first threshold and the second threshold, in which, in response to the fourth quantity of consecutive times reaching a fourth predetermined quantity, the controller is configured to determine that there is human motion.

In conclusion, according to the above embodiments of the human presence detection system and the human motion detection system of the disclosure, a thermal sensor assembly is used to function as a human presence detector or a human motion detector. The systems operatively maximize accuracy and speed of human presence and motion detection while minimizing cost of hardware system through collaboration of algorithms performed by the controller and a hardware arrangement having the thermal sensor.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A human presence detection system, comprising:
a thermal sensor;
a lens mounted on the thermal sensor, configured to focus thermal radiation incident from a spatial zone onto the thermal sensor, wherein the thermal sensor is configured to sense the thermal radiation from the spatial zone and output a temperature signal; and
a controller, coupled to the thermal sensor, configured to set a first threshold and a second threshold, wherein the first threshold is greater than the second threshold, and to detect human presence according to the temperature signal, the first threshold and the second threshold;
wherein the controller comprises a low-pass filter and a Kalman filter, the controller is further configured to input the temperature signal into the low-pass filter, and the low-pass filter is configured to output a filtered temperature signal;
wherein the controller is further configured to obtain a first difference signal by computing a difference between the temperature signal and the filtered temperature signal, and to input the first difference signal into the Kalman filter, and wherein the Kalman filter is configured to output a second difference signal.

2. The human presence detection system according to claim 1, wherein:
in response to the second difference signal being less than the first threshold and greater than the second threshold, the controller is configured to determine that there is no human presence;
in response to the second difference signal being greater than both the first threshold and the second threshold, the controller is configured to determine that there is human presence; and
in response to the second difference signal being less than both the first threshold and the second threshold, the controller is configured to determine that there is human presence.

3. The human presence detection system according to claim 1, wherein the low-pass filter is a weighted low-pass filter.

4. The human presence detection system according to claim 1, wherein the first threshold is greater than zero, and the second threshold is less than zero.

5. The human presence detection system according to claim 1, wherein the controller is configured to count a first quantity of consecutive times that the second difference signal is greater than both the first threshold and the second threshold; wherein, in response to the first quantity of consecutive times reaching a first predetermined quantity, the controller is configured to determine that there is human presence.

6. The human presence detection system according to claim 1, wherein the controller is configured to count a second quantity of consecutive times that the second difference signal is less than both the first threshold and the second threshold; wherein, in response to the second quantity of consecutive times reaching a second predetermined quantity, the controller is configured to determine that there is human presence.

7. A human motion detection system, comprising:
a thermal sensor;
a lens mounted on the thermal sensor, configured to focus thermal radiation incident from a spatial zone onto the thermal sensor, wherein the thermal sensor is configured to sense the thermal radiation from the spatial zone and output a temperature signal; and
a controller, coupled to the thermal sensor, configured to set a first threshold and a second threshold, wherein the first threshold is greater than the second threshold, and to detect human motion according to the temperature signal, the first threshold and the second threshold;
wherein the controller comprises a differentiator and a median filter, the controller is configured to input the temperature signal into the differentiator, and the differentiator is configured to output a rate of change of the temperature signal;
wherein the controller is further configured to input the rate of change of the temperature signal into the median filter, and the median filter is configured to output a filtered rate of change of the temperature signal.

8. The human motion detection system according to claim 7, wherein:
in response to the filtered rate of change of the temperature signal being less than the first threshold and the filtered rate of change of the temperature signal being greater than the second threshold, the controller is configured to determine that there is no human motion;
in response to the filtered rate of change of the temperature signal being greater than both the first threshold and the second threshold, the controller is configured to determine that there is human motion; and
in response to the filtered rate of change of the temperature signal being less than the both first threshold and the second threshold, the controller is configured to determine that there is human motion.

9. The human motion detection system according to claim 7, wherein the first threshold is greater than zero, and the second threshold is less than zero.

10. A human motion detection system, comprising:
a thermal sensor;
a lens mounted on the thermal sensor, configured to focus thermal radiation incident from a spatial zone onto the thermal sensor, wherein the thermal sensor is configured to sense the thermal radiation from the spatial zone and output a temperature signal; and
a controller, coupled to the thermal sensor, configured to set a first threshold and a second threshold, wherein the first threshold is greater than the second threshold, and to detect human motion according to the temperature signal, the first threshold and the second threshold;
wherein the controller is configured to perform a convolution process on the temperature signal to obtain a convolution signal.

11. The human motion detection system according to claim 10, wherein:
in response to the convolution signal being less than the first threshold and greater than the second threshold, the controller is configured to determine that there is no human motion;
in response to the convolution signal being greater than both the first threshold and the second threshold, the controller is configured to determine that there is human motion; and
in response to the convolution signal being less than both the first threshold and the second threshold, the controller is configured to determine that there is human motion.

12. The human motion detection system according to claim 10, wherein the convolution process comprises:
obtaining a quantity of samples to be convoluted;
performing following processes for each of the samples to be convoluted:
obtaining values of a current state and a previous state of the temperature signal;
computing a time difference between the current state and the previous state;
obtaining a plurality of convolution values by multiplying the value of the current state, the value of the previous state and the time difference; and
obtaining a sum of the plurality of convolution values to obtain the convolution signal.

13. The human motion detection system according to claim 10, wherein the controller comprises a low-pass filter, the controller is configured to input the convolution signal into the low-pass filter, and the low-pass filter is configured to output a filtered convolution signal, wherein:
in response to the filtered convolution signal being less than the first threshold and greater than the second threshold, the controller is configured to determine that there is no human motion;
in response to the filtered convolution signal being greater than both the first threshold and the second threshold, the controller is configured to determine that there is human motion; and
in response to the filtered convolution signal being less than both the first threshold and the second threshold, the controller is configured to determine that there is human motion.

14. The human motion detection system according to claim 13, wherein the low-pass filter is a weighted moving average filter.

15. The human motion detection system according to claim 10, wherein the controller is further configured to count a third quantity of consecutive times that the convolution signal is greater than both the first threshold and the second threshold; wherein, in response to the third quantity of consecutive times reaching a third predetermined quantity, the controller is configured to determine that there is human motion.

16. The human motion detection system according to claim 10, wherein the controller is further configured to count a fourth quantity of consecutive times that the convolution signal is less than both the first threshold and the second threshold; wherein, in response to the fourth quantity of consecutive times reaching a fourth predetermined quantity, the controller is configured to determine that there is human motion.

17. The human motion detection system according to claim 10, wherein the first threshold is greater than zero, and the second threshold is less than zero.
